(19) United States
(12) Patent Application Publication
(10) Pub. No.: US 2006/0139529 A1
(43) Pub. Date: Jun. 29, 2006

(54) Manufacturing method for a transflective liquid crystal display device

(76) Inventors: Shie-Chang Jeng, Ping Tung Hsien (TW); Kang-Hung Liu, Tao Yuan Hsien (TW); Chi-Chang Liao, Tai Nan City (TW); Cheng-Hsi Hsieh, Kao Hsiung City (TW)

Correspondence Address: RABIN & BERDO, P.C., Suite 500, 1101 14 Street, N.W., Washington, DC, 20005, US

(21) Appl. No.: 11/362,902

(22) Filed: Feb. 28, 2006

Related U.S. Application Data
(63) Continuation-in-part of application No. 11/090,279, filed on Mar. 28, 2005.

(30) Foreign Application Priority Data
Aug. 31, 2004 (TW) 93126249

(51) Int. Cl. G02F 1/1335

(52) U.S. Cl. 349/114

(57) ABSTRACT

A manufacturing method for a transflective liquid crystal device is proposed. In various embodiments, two types of liquid crystal with distinguishing material features are adopted to be injected into a transmissive region and a reflective region respectively. Consequently, the two separated regions filled with the LCD materials have identical electro-optical characteristics so as to implement an excellent single cell gap transflective LCD. The claimed subject matter uses a continuous manufacturing process, such as the steps of molding, printing, coating or the like, to reduce costs.

### CROSS-REFERENCE TO RELATED APPLICATIONS

This application is a Continuation-in-Part of application Ser. No. 11/090279, filed on 28 Mar. 2005, and which claimed priority from Taiwanese Application No. 93126249, filed Aug. 31, 2004.

### BACKGROUND OF THE INVENTION

1. Field of the Invention

The present invention relates to a manufacturing method for a transflective liquid crystal display device, and more particularly to a single cell gap transflective liquid crystal display produced by injecting two kinds of liquid crystal molecules into a reflective region and a transmissive region respectively.

2. Description of Related Art

For a conventional liquid crystal display (LCD), a transmissive-type LCD has a better image quality used in a darker environment. A reflective-type LCD meanwhile, has a better image quality in brighter environment as its display quality relies upon an external light source. Moreover, the reflective-type liquid crystal displayer uses less power because it does not require a backlight.

Therefore, a transflective-type liquid crystal displayer utilizes both merits of transmissive-type LCD and a reflective-type LCD by using a backlight and surrounding light as its light source.

In the embodiment of the transflective liquid crystal display, the lengths of optical path for the light propagating in the transmissive region and the reflective region are different. Specifically, the length of optical path in the reflective region is about twice of that in the transmissive region. That is the reason that earlier transflective LCDs with single cell gaps could not achieve optimum electro-optical performance.

FIG. 1 shows a transflective display device with a single cell gap. The display device has a transmissive region 102, and a reflective region 104, wherein the liquid crystal layer 112 is interposed between a top-substrate 106 and a bottom-substrate 108. A reflective plate 110 is utilized to reflect an incident light, a top-polarizer 130 is mounted above the top-substrate 106, and a bottom-polarizer 132 is mounted below the bottom-substrate 108. Moreover, the top-polarizer 130 and the bottom-polarizer 132 mounted on the substrates are orthogonal to each other. The liquid crystal layer provides a certain phase retardation for the light in an electric field to obtain bright or dark conditions. Furthermore, a backlight module 134 used for generating the transmissive light is mounted below the display device.

Under a normally white state of the transflective liquid crystal displayer, both the transmissive region and the reflective region are in the white state without an applied electric field. In such operation mode, a phase retardation (Δn·d, d is the cell gap) of λ/2 for transmissive region and λ/4 for reflective region is required to obtain an optimum electro-optical performance. Therefore, it is impossible to meet the requirement for both of the reflective region and transmissive region for a single cell gap liquid crystal display because the length of optical path of light propagating in the reflective region is two times of that in the transmissive region as shown in FIG. 1.

To overcome the above mentioned problems, both U.S. Pat. No. 6,295,109 and No. 6,819,379 provide a liquid crystal display device with dual cell gap structure as shown in FIG. 2, which shows a liquid crystal layer 33 interposed between the first substrate 34 and the second substrate 34′. A first phase compensation element 32 and a second phase compensation element 32′ are located on the each side of the substrates. A first polarizer 30 and a second polarizer 30′ are provided for controlling whether light is transmitted or not. The dual cell gap structure is designed to make both of the transmissive region and reflective region with the same length of optical path. Therefore, the gap D2 in the reflective region of the liquid crystal layer 33 is half of the gap D1 in the transmissive region. Even though the above dual cell gap structure can achieve an optimum electro-optical performance of phase retardation λ/2 in the transmissive region and λ/4 in the reflective region, this complicated structure lowers the yield and increases the cost as the manufacturing method for the display device needs to precisely control the height of the two different gaps.

For improving the complicated structure of the above-mentioned dual-gap transflective LCD, a single cell gap transflective LCD was proposed by adjusting the liquid crystal composition of the transmissive and the reflective regions. For example, U.S. patent application Ser. No. 11/090,279 provided by ITRI (Industrial Technology Research Institute) discloses a new transflective liquid crystal display device. Two types of the liquid crystal (dual-LC compositions) having different optical anisotropic (Δn) are filled into the transmissive region and the reflective region respectively. Therefore, light propagating in the transmissive region and in the reflective region can meet the optimal requirements of phase retardation λ/2 in the transmissive region and λ/4 in the reflective region in single cell gap structure.

Another example is U.S. Patent Pub. No. 2005/0012879, which discloses a single cell gap transflective LCD. Two types of the liquid crystal having different concentrations of chiral dopant are filled into the transmissive region and the reflective region respectively. Therefore, it can reach the optimal electro-optical performance.

FIG. 3 shows the single cell gap transflective LCD having a reflective region and a transmissive region in a pixel with different LC compositions. The liquid crystal layer is separated into a first LC layer 412A and a second LC layer 412B by a partition wall 446, the two layers form a transmissive region 402 and a reflective region 404. The liquid crystal layers (412A, 412B) are interposed between a top-substrate 406 and a bottom-substrate 408. A reflective plate 410 is located at the position corresponding to the reflective region 404 on the bottom-substrate 408. Whereby, the transmissive region 402 and the reflective region 404 are defined.

The quarter-wavelength plates 426A, 426B and the polarizers 428A, 428B are mounted on the sides of the two substrates. A common electrode 422 is disposed on the top-substrate 406, and a pixel electrode 424 is disposed on the bottom-substrate 408. When a light propagates through the structure, the polarizer can control whether or not the polarized light of a certain direction can pass. The alignment films 442, 444 are utilized to align the liquid crystal molecules. A backlight module 434 generates a light propagating through the transmissive region 402 so as to form a transmissive light, and an incident ambient light reflected from the reflective region 404 forms a reflective light.

By adjusting the liquid crystal composition of the aforementioned single cell gap transflective LCD, the prior art can reach the optimum electro-optical effect for both of the reflective and transmissive regions. In order to simplify the manufacturing method of such dual-LC-compositions transflective LCD, the present invention provides a manufacturing method to reduce costs and increase yield.

### SUMMARY OF THE INVENTION

The present invention relates to a manufacturing method for a dual-LC-composition transflective LCD with single cell gap by means of a continuous process. The structure of the display device comprising of multiple partition walls, reflective plates, alignment films, and the wide-viewing-angle structures, such as protrusions and patterned electrodes. Those components are manufactured via the process of replication, printing, coating or the like, wherein the replication process includes molding, embossing and casting, and the printing process includes inkjet printing, flexographic printing, gravure printing, and screen printing. Furthermore, an inkjet printing method is used to fill the color resist to form color filter and to fill two types of liquid crystal molecules into the transmissive regions and the reflective regions respectively. Consequently, a transflective LCD with a single cell gap can reach an optimum electro-optical design.

For the second embodiment in the assembling process, a protective top layer and alignment layer are accomplished by means of phase separation. This method reduces the step of assembling substrates, and the transflective LCD device becomes a single substrate LCD.

The preferred embodiment of the present invention comprises: providing a first substrate; forming a first electrode layer on the first substrate; forming multiple reflective plates on the first substrate; forming a first alignment layer on the first electrode layer and the reflective plates; forming a plurality of partition walls on the first alignment layer; injecting two types of liquid crystal material into the transmissive regions and the reflective regions respectively, wherein the transmissive and the reflective regions are separated by the plurality of partition walls, a step of providing a second substrate; forming a second electrode layer on the second substrate; forming a second alignment layer on the second electrode layer; and finally assembling the transflective LCD device.

The methods of forming the plurality of partition walls, the reflective plates, the electrode layer, the alignment layer and the wide-viewing-angle structures can be achieved via a process of replication, printing and coating, wherein the replication process includes molding, embossing and casting, and the printing process includes inkjet printing, flexographic printing, gravure printing, and screen printing. The partition walls separate the transmissive and the reflective regions and serve as the spacers of the transflective LCD for controlling the cell gap. The above-mentioned structures of the display device, such as partition walls, can be fabricated on either of the substrates. Furthermore, the second substrate can be omitted by using the phase separation method for the mixture of the liquid crystal molecules, monomer and material with alignment function. After phase separation, a protective top layer and alignment layer are accomplished and a single substrate transflective LCD is formed by applying one electrode layer on the protective top layer. In another embodiment, a color transflective LCD is developed by injecting color resist to the partition walls served as the bank structures.

### BRIEF DESCRIPTION OF DRAWINGS

The present invention will be more readily understood by referring to the following detailed description in conjunction with the accompanying drawings, in which:

FIG. 1 is a schematic diagram for a transflective LCD with a single-LC layer of the prior art;

FIG. 2 is a schematic diagram showing the different gap structure in the LC layer of the transflective LCD of the prior art;

FIG. 3 is a schematic diagram showing the different LC composition interposed in the transmissive and reflective regions of the display device of the prior art;

FIG. 4A to FIG. 4G shows the structure illustrating a manufacturing method of the present invention;

FIG. 5 is a schematic diagram of the transflective LCD structure of the present invention;

FIG. 6 is a flowchart of the manufacture procedure for the transflective LCD of the present invention; and

FIG. 7 is a flowchart of the manufacture procedure for the transflective LCD with single substrate.

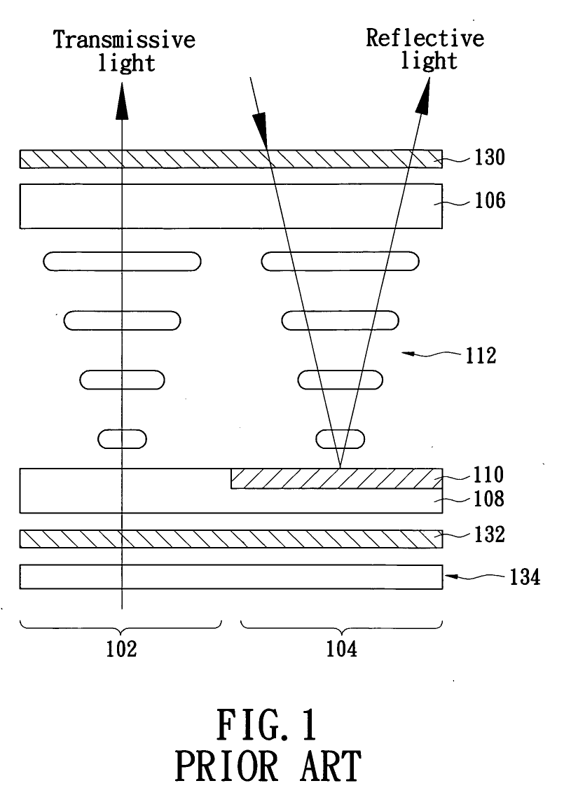

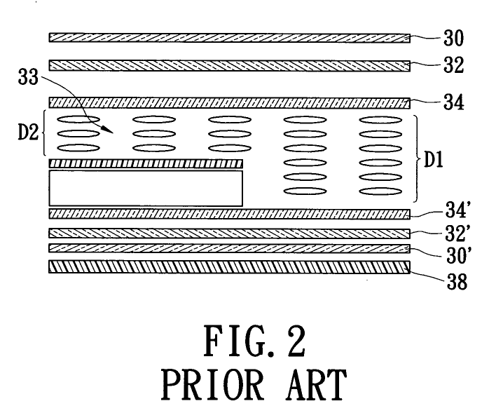

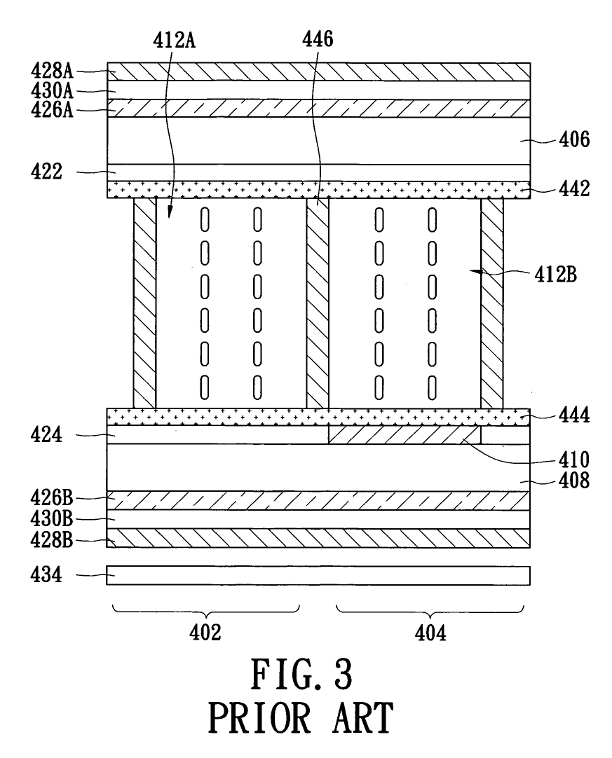

### DETAILED DESCRIPTION OF THE PREFERRED EMBODIMENTS

To understand the technology, means and functions adopted in the present invention further referring to the following detailed description and attached drawings. The invention shall be readily understood deeply and concretely from the purpose, characteristics and specification. Nevertheless, the present invention is not limited to the attached drawings and embodiments in following description.

The present invention relates to a manufacturing method for a single cell gap transflective LCD device, which is used to improve the displaying quality of a reflective-type displayer in darker surroundings and a transmissive-type displayer in brighter surroundings. This single cell gap transflective LCD achieves a required optimal electro-optical design by filling two types of LC compositions to the corresponding transmissive regions and the reflective regions, respectively. In particular, a continuous manufacture compatible process is employed for the invention to reduce production costs and increase yield.

The previously mentioned continuous manufacture compatible process includes a method of replication, printing, coating, phase separation or the like, wherein the replication process includes molding, embossing and casting, and the printing process includes inkjet printing, flexographic printing, gravure printing, and screen printing. Multiple partition walls used to separate the dual-LC compositions with different characteristics in the single cell gap transflective LCD can also be fabricated via the step of replication, printing, coating or the like. These manufacture methods can also be used to fabricate reflective plates, alignment films, and wide-viewing-angle structures within the transflective LCD. Moreover, color resists can be injected between the partition walls by the method of ink-jet printing, as well as the dual-LC compositions can also be injected into the transmissive and the reflective regions respectively. That is, the transflective LCD having single-cell structure can accomplish an optimum performance with color image. Additionally, a single-substrate structure thereof can be formed by way of phase separation to simplify the manufacturing process and reduce costs.

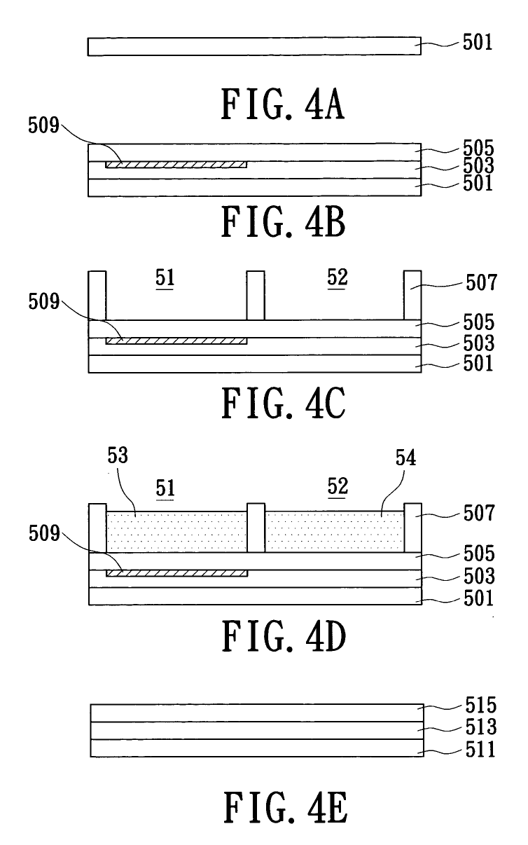

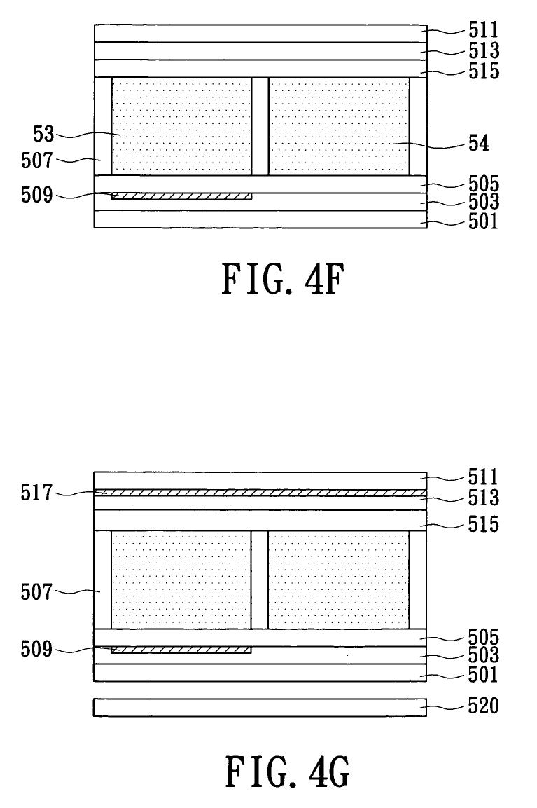

FIGS. 4A to 4G show the preferred embodiment of the present invention illustrating the manufacturing method for the dual-LC compositions transflective LCD with single cell gap. Thus, the present invention solves the inconsistent phase retardation between the reflective region and transmission region that result from the optical path in the reflective region of the conventional transflective LCD to be twice that of the optical path in the transmissive region.

The order of the manufacture steps, such as the orders shown in FIG. 4 and the like, is not limited in this embodiment. FIG. 4A shows the first step of preparing a first substrate 501, such as a glass substrate, a plastic substrate or the like. Next, the contiguous structures, such as the partition walls, are formed via the steps of replication, printing, coating or the like, wherein the replication process includes molding, embossing and casting, and the printing process includes inkjet printing, flexographic printing, gravure printing, and screen printing. Furthermore, the other structures, such as the reflective plates, the electrode layers, the alignment layers, and the wide-viewing-angle protrusion can also be formed via the above-mentioned manufacture methods.

FIG. 4B shows a first electrode layer 503, a reflective plate 509 and a first alignment layer 505 formed on the first substrate 501, wherein the first alignment layer 505 needs to contact with a liquid crystal layer of the display device as shown in FIG. 4C.

In the embodiment of the continuous manufacture compatible process, multiple partition walls 507 and the reflective plates 509 are formed simultaneously on the first substrate 501 by a method of replication, printing, coating or the like. A reflective region 51 and a transmissive region 52 in a pixel are separated by the partition walls 507. A reflective plate 509 is formed in the reflective region 51, and the reflective plate 509 in the preferred embodiment is formed between the first electrode layer 503 and the first alignment layer 505.

The manufacturing method of the present invention are not limited to the above-mentioned embodiment. For example, the partition walls 507 can be fabricated on the first alignment layer 505 by the conventional process of photolithography, while the electrode layer can also be fabricated via a conventional sputtering process. Additionally, the reflective plate 509 and the partition walls 507 can be formed simultaneous by replication, or the reflective plate 509 can be formed between the first alignment layer 505 and the first electrode layer 503 via the sputtering process.

Another structure, for example, a phase compensation film (not shown in figure) or a polarizer (not shown in figure) can be formed on the aforementioned substrates.

Furthermore, the above-mentioned partition walls 507 not only separate the pixel into the transmissive and the reflective regions, the partition walls also serve as the spacers of the cell gap and the bank structure of color resist. If the plurality of separated regions are filled up with color resist, a color transflective liquid crystal display device is implemented as well.

After manufacture process shown in FIG. 4C, a liquid crystal layer is formed as shown in FIG. 4D. A process of inkjet printing is used to inject two types of liquid crystal molecules with different characteristics into the transmissive region 52 and the reflective region 51 respectively. FIG. 4D shows a display pixel including a transmissive LC layer 54 and a reflective LC layer 53. The two types of liquid crystal are used to solve the improper electro-optical performance caused by the different optical paths thereof.

Next, a second substrate and its contiguous structures are formed as shown in FIG. 4E. The second substrate 511, such as a glass substrate or a plastic substrate, is provided. A second electrode layer 513 and a second alignment layer 515 are formed on the second substrate 511. Finally, the second substrate 511 and the first substrate 501 are assembled by lamination to form the transflective LCD device as shown in FIG. 4F.

Consequently, the above-mentioned electrode layer 503 (formed via a step of replication, printing or sputtering in a preferred embodiment), the alignment layer 505, the partition walls 507, the reflective plate 509 and the liquid crystal layers 53, 54, and the second substrate 511 with its contiguous structure are fabricated to form a display cell.

In a preferred embodiment of the present invention, the substrates further comprise a phase compensation element, polarizer and the like (not shown in the figures).

In another preferred embodiment of the present invention, the liquid crystal composition is a mixture of liquid crystal molecules, monomer, and materials with an alignment function, then the second substrate 511 can be omitted and replaced with a protective top layer and an alignment layer formed via the step of phase separation. After that, one conducting layer is formed thereon so as to form the transflective LCD with a single substrate. Wherein, the phase separation is implemented via the process of photo-induced phase separation or thermal-induced phase separation.

In one preferred embodiment, the reflective region 51 and the transmissive region 52 separated by the partition walls 507 form the reflective LC layer 53 and the transmissive LC layer 54. The spaces between the partition walls and the substrates are filled up with the liquid crystal molecules with different characteristics in the reflective region and transmissive region, respectively. Thereby, the liquid crystal molecules are filled by the process of inkjet printing, flexographic printing, gravure printing, screen printing or the like. The two types of the liquid crystal molecules of the present invention are used to overcome the difference of optical path between reflective region and transmissive region in a single cell gap transflective LCD, therefore the optimum electro-optical performance is reached both in reflective region and in transmissive region.

FIG. 4G shows a preferred embodiment of a color transflective LCD, which incorporates a color filter layer 517 formed in one side of the second substrate 511 using the step of inkjet printing or photolithography. Moreover, the color filter layer 517 can also be formed on the first substrate 501 by inject color resist into the bank structures of partition walls.

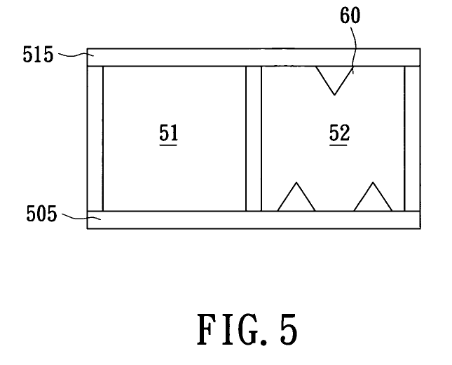

To fabricate a LCD with wide-viewing-angle performance, the wide-viewing-angle structures are formed in the liquid crystal layer so as to extend the viewing angle of the display device. The wide-viewing-angle structure can be the structure of protrusion 60 shown in FIG. 5 or a patterned electrode (not shown in the figure). The process for manufacturing the wide-viewing-angle structure can be a process of replication, printing, coating or photolithography, wherein the replication process includes molding, embossing and casting, and the printing process includes inkjet printing, flexographic printing, gravure printing, and screen printing. Furthermore, the wide-viewing-angle structure, the alignment layer, the reflective plate and the partition walls can be formed simultaneously via a process of replication.

The manufacturing method for the transflective display device implemented in the preferred embodiment of the present invention is not limited to the above disclosure and the process order. Moreover, a backlight module 520 is mounted below the display cell. The backlight module 520 can be a side-edged type module or a direct type module. When a flexible direct type backlight module or a side light source with a flexible light-guide plate is mounted on the side of the bottom-substrate, the display device can be a flexible transflective LCD.

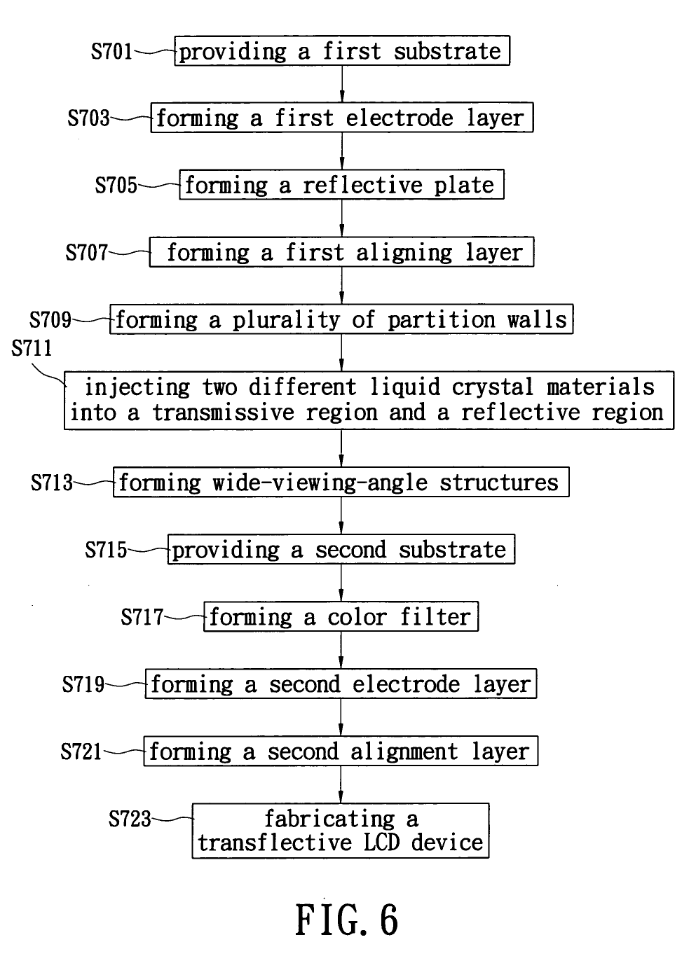

Referring to FIG. 6 showing a flow chart of the manufacture method for the transflective display device in a preferred embodiment. Firstly, a first substrate is provided (step S701), and the first substrate's contiguous structure is formed later. A first electrode layer is formed on the first substrate (step S703), and a reflective plate is formed (step S705), next an alignment layer is formed (step S707). The reflective plate defines the reflective region of the transflective liquid crystal display device. Accordingly, a plurality of partition walls are formed to separate the device into the reflective regions and the transmissive regions (step S709). By means of the continuous process, the above-mentioned structure, such as the electrode layer, the alignment layer, the reflective plate and the partition walls can be fabricated simultaneously.

Two types of liquid crystal molecules having different characteristics are filled into the reflective regions and the transmissive regions via the process of printing (step S711). Furthermore, for creating a display with a wider viewing angle, the wide-viewing-angle structure is utilized to be formed on the first substrate and the second substrate. (step S713).

Thereafter, a second substrate and its contiguous structure are formed. In Step S715, the second substrate is provided, then a second electrode layer is formed on the second substrate (step S719). In addition, a color filter layer can be formed between the structure of the substrate and the electrode layer so as to develop a color transflective LCD (step S717). Next, a second alignment layer is formed in step S719.

Finally, the second substrate and its contiguous structure are laminated with the first substrate and its contiguous structure to form the transflective LCD of the present invention (step S723).

The manufacturing procedure for the transflective display device implemented in the preferred embodiment of the present invention is not limited to the above order.

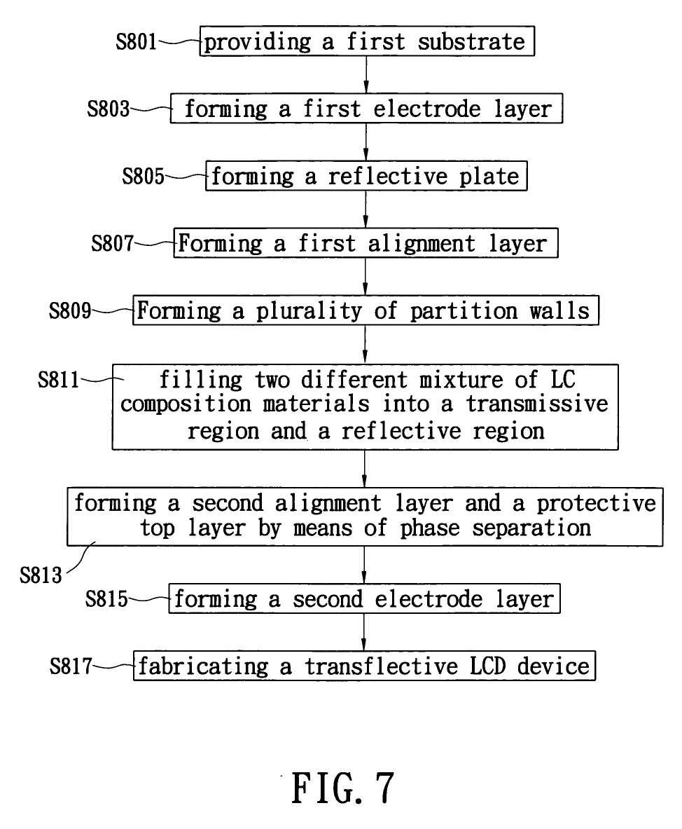

In another preferred embodiment of manufacture, if the monomer and the alignment material are added with the liquid crystal molecules, the second substrate can be omitted. Referring to FIG. 7, wherein a protective top layer and an alignment layer are formed by means of phase separation, and a transflective LCD with single-substrate structure is implemented. Please refer to the detailed steps illustrated in FIG. 4A to FIG. 4F. The manufacture procedure is outlined in FIG. 7.

Firstly, a first substrate is provided (step S801), and a first electrode layer is formed on the first substrate (step S803). Next, a reflective plate is formed (step S805), and a first alignment layer is formed afterward (step S807). In Step S809, a plurality of partition walls is formed.

The plural partition walls separate the display cell into the reflective regions and the transmissive regions. In Step S811, two types of the liquid crystal molecules, the monomer and the alignment materials are injected into the reflective regions and the transmission regions so as to form a LC layer, respectively. An alignment layer and a protective top layer are formed by means of phase separation (step S813). After that, a second electrode layer is formed (step S815). Then the transflective LCD is developed (step S817). Furthermore, a backlight module is mounted below the display cell.

To sum up, the present invention relates to a manufacturing method for a single cell gap transflective LCD, wherein the reflective region and the transmissive region can reach the same electro-optical performance by means of injecting two types of LC with different characteristics into the reflective and transmissive regions, respectively.

The many features and advantages of the present invention are apparent from the written description above and it is intended by the appended claims to cover all. Furthermore, since numerous modifications and changes will readily occur to those skilled in the art, it is not desired to limit the invention to the exact construction and operation as illustrated and described. Hence, all suitable modifications and equivalents may be resorted to as falling within the scope of the invention.

What is claimed is:

1. A manufacturing method for a single cell gap transflective liquid crystal display device, comprising:
providing a first substrate;
forming a first electrode layer on the first substrate;
forming a reflective plate on the first substrate;
forming a first alignment layer on the first electrode layer and the reflective plate;
forming a plurality of partition walls on the first alignment layer;
injecting two types of liquid crystal molecules into the transmissive regions and the reflective regions respectively, wherein the transmissive and the reflective regions are separated by the plurality of partition walls;
providing a second substrate;
forming a second electrode layer on the second substrate;
forming a second alignment layer on the second electrode layer; and
assembling each component and forming the transflective liquid crystal display device.

2. The manufacturing method of claim 1, wherein the electrode layer is formed by a method of sputtering, molding, embossing, casting, inkjet printing, flexographic printing, gravure printing, or screen printing.

3. The manufacturing method of claim 1, wherein the reflective plate is formed by a method of sputtering, molding, embossing, casting, inkjet printing, flexographic printing, gravure printing, or screen printing.

4. The manufacturing method of claim 1, wherein the partition walls are formed by a method of molding, embossing, casting, inkjet printing, flexographic printing, gravure printing, screen printing, coating, or photolithography.

5. The manufacturing method of claim 1, wherein the reflective plate and the partition walls are formed by a method of molding, embossing or casting simultaneously.

6. The manufacturing method of claim 1, wherein the alignment layer, reflective plate and the partition walls are formed by a method of molding, embossing or casting simultaneously.

7. The manufacturing method of claim 1, wherein the liquid crystal layer is formed by a method of inkjet printing.

8. The manufacturing method of claim 1, wherein the liquid crystal layer is formed by a method of flexographic printing.

9. The manufacturing method of claim 1, further comprising wide-viewing-angle structures formed on the first substrate or the second substrate so as to widen the viewing angle of the display device.

10. The manufacturing method of claim 9, wherein the wide-viewing-angle structures are formed with the structure of protrusions or patterned electrodes.

11. The manufacturing method of claim 9, wherein the method of forming the wide-viewing-angle structures comprises a method of molding, embossing, casting, inkjet printing, flexographic printing, gravure printing, screen printing, coating, or photolithography.

12. The manufacturing method of claim 9, wherein the wide-viewing-angle structures are fabricated simultaneously with the alignment layer, the reflective plate and the partition walls by the method of molding, embossing, or casting.

13. The manufacturing method of claim 1, further comprising a color filter fabricated on either of the substrates.

14. A manufacturing method for a transflective liquid crystal display device, comprising:
providing a first substrate;
forming a first electrode layer on the first substrate;
forming a reflective plate on the first substrate;
forming a first alignment layer on the first electrode layer and the reflective plate;
forming a plurality of partition walls on the first alignment layer;
injecting two types of liquid crystal molecules, monomer and alignment materials into a transmissive region and a reflective region respectively, wherein the transmissive and the reflective regions are separated by the plurality of partition walls;
performing a step of phase separation to form an alignment layer and a top-protective layer;
forming a second electrode layer; and
assembling each component to form the transflective liquid crystal display device.

15. The manufacturing method of claim 14, wherein the electrode layer is formed by a method of sputtering, molding, embossing, casting, inkjet printing, flexographic printing, gravure printing, or screen printing.

16. The manufacturing method of claim 14, wherein the partition walls are formed by a method of molding, embossing, casting, inkjet printing, flexographic printing, gravure printing, coating, or photolithography.

17. The manufacturing method of claim 14, wherein the reflective plate is formed by a method of sputtering, molding, embossing, casting, inkjet printing, flexographic printing, gravure printing, or screen printing.

18. The manufacturing method of claim 14, wherein the reflective plate and the partition walls are formed simultaneously by a method of molding, embossing or casting.

19. The manufacturing method of claim 14, wherein the alignment layer, reflective plate and the partition walls are formed simultaneously by a method of molding, embossing or casting.

20. The manufacturing method of claim 14, wherein the liquid crystal layer is formed by a method of inkjet printing or flexographic printing.

21. The method as recited in claim 14, wherein the step of phase separation is a step of photo-induced phase separation or thermal-induced phase separation.

22. The manufacturing method of claim 14, further comprising wide-viewing-angle structures formed on the first substrate or the second substrate so as to widen the viewing angle of the display device.

23. The manufacturing method of claim 22, wherein the wide-viewing-angle structures are formed with the structure of protrusions or patterned electrodes.

24. The manufacturing method of claim 23, wherein the method of forming the wide-viewing-angle structures comprise a method of molding, embossing, casting, inkjet printing, flexographic printing, gravure printing, coating, or photolithography.

25. The manufacturing method of claim 22, wherein the wide-viewing-angle structures are fabricated simultaneously with the alignment layer, the reflective plate and the partition walls by the method of molding, embossing or casting.

26. The manufacturing method of claim 14, further comprising a color filter fabricated on either of the substrate.
